(19) United States
(12) Patent Application Publication
(10) Pub. No.: US 2014/0244507 A1
(43) Pub. Date: Aug. 28, 2014

(54) OFFLINE TRANSACTION

(71) Applicant: Sture Udd, Vaasa (FI)

(72) Inventor: Sture Udd, Vaasa (FI)

(73) Assignee: UPC KONSULTOINTI OY, Vaasa (FI)

(21) Appl. No.: 14/235,412

(22) PCT Filed: Jul. 28, 2011
(86) PCT No.: PCT/FI2011/050678

§ 371 Date: Apr. 9, 2014

(51) Int. Cl. G06Q 20/32; G06Q 20/38

(52) U.S. Cl. CPC G06Q 20/3274; G06Q 20/385
USPC 705/44

(57) ABSTRACT

An electronic device, including a code creator for creating a machine-readable transaction code for identifying an information transaction between the electronic device and a second electronic device, the transaction code including information on a first security document and on one or more first identifiers for uniquely identifying the transaction, and a communication unit for providing the transaction code to be receivable by the second electronic device.

### FIELD OF THE INVENTION

The invention relates to an offline transaction of a security document between electrical apparatuses.

### BACKGROUND OF THE INVENTION

One form of an offline transaction, offline payment, has a long history. It includes non-electronic payment methods, such as money, cheque, bank draft and postal order. As technology has advanced, other payment methods have been introduced. Electronic ways of payment, such as stripe card, contactless card and mobile handset, have been introduced.

In one payment model of mobile payment, a short message service (SMS) based payment is used. The consumer may send a payment request with an SMS text message to a short code, and the charge is applied to his phone bill or mobile wallet. The merchant is informed if the payment was successful, after which he can release the goods.

A plurality of disadvantages are associated with SMS-based paying. For instance, the reliability of the service is poor as transactions can easily get lost. Furthermore, security is a big issue as a message is subject to fraud whenever it arrives at the radio interface. A slow speed of the system is also a problem, since the confirmation message to the merchant can take minutes or even hours, whereas the consumer buying the goods in a shop and using the service can only wait tens of seconds at the maximum.

A more developed and popular way of payment is an online payment method, so-called direct mobile billing method, which can be applied at an e-commerce site, for instance. To carry out a payment, the consumer enters a two-factor authentication involving a PIN (personal identification number) and a one-time password. The consumer's mobile account is charged for the purchase. The direct mobile billing method eliminates most of the deficiencies of the SMS-based payment in that the method is secure and fast.

However, the direct mobile billing method is only applicable at an e-commerce site and cannot be used everywhere. Furthermore, the payment method is dependent, as well as other online payment methods, on the operation of the wireless communication network, such as the mobile Internet.

As mobile stations are so common today, a solution to carry out secure offline payments and to carry out other secure offline transactions by using a mobile station is called for.

### BRIEF DESCRIPTION

An object of the present invention is to provide a secure offline transaction method and devices capable of carrying out offline transactions. The invention is disclosed in the independent claims. Some embodiments are disclosed in the dependent claims.

The invention provides a secure way to carry out offline transactions between electronic devices.

### DRAWINGS

In the following the invention will be described in greater detail by means of preferred embodiments with reference to the attached drawings, in which

FIGS. 1A to 1D show an embodiment of an offline transaction;

FIG. 2 shows an embodiment of a method; and

FIG. 3 shows an embodiment of an apparatus.

### DESCRIPTION OF SOME EMBODIMENTS

In the following embodiments, reference is mainly made to optical reading of codes. However, the invention is not limited thereto, but any form of wireless reading may be applied. Examples of wireless reading are optical, magnetic and radio frequency reading.

The following embodiments refer to offline transactions. Offline refers to a transaction where the devices participating in the transaction do not have a connection to a general data network, such as a mobile network or the Internet.

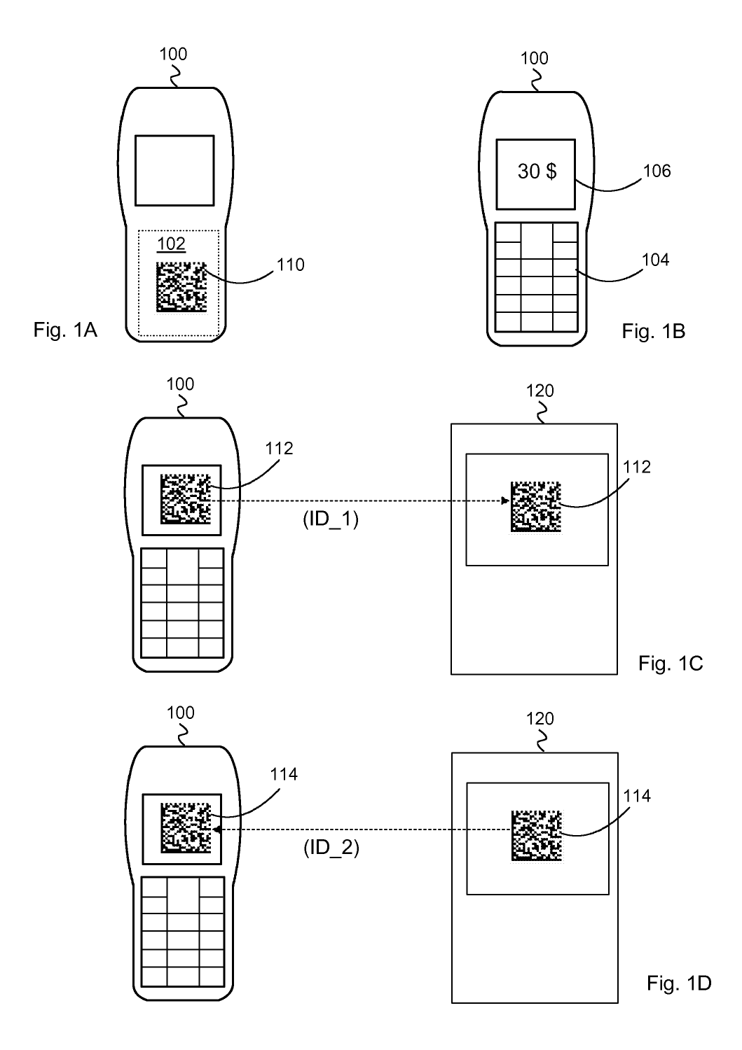

FIGS. 1A to 1D show an embodiment of the invention. In the example of FIGS. 1A to 1D, it is assumed that a user wishes to refuel his/her car at a petrol station.

The user wishing to refuel his car is using a mobile phone 100. The mobile phone comprises a memory 102 for storing digital information therein. In FIG. 1A, digital information representing a wirelessly readable code CODE#1 110 has been stored in the memory 102. In the current embodiment, the code contains information on the funds stored on the mobile phone 100. The funds may be 100 USD, for instance. In an embodiment, the user may have pre-paid a corresponding amount of money 100 USD at a kiosk, for instance, after which the paid sum is transferred to a financing institution, which subsequently will then refund the mobile phone user's payments to the sellers of the items.

Upon paying 100 USD to the kiosk, the user receives a code (CODE#1) to his mobile phone, which represents the funds of 100 USD. The user may receive the code by reading it optically with the camera of the mobile phone from a display of a device at the kiosk, for instance. Upon reading the code, the mobile phone stores it in the memory 102 of the mobile phone. Alternatively, the user may receive the code CODE#1 as a radio message, such as an SMS (Short Message Service) message or an MMS (Multimedia Service Message) message. An example of the use of the radio message is when a parent sends a code, which represents a sum of money, to a child who is currently shopping. The child's mobile phone then contains the received funds, which the child can then use for shopping.

The mobile phone 100 may thus obtain the code either by reading it wirelessly from another device or by receiving it attached to a radio message.

FIG. 1B illustrates a situation where funds stored in the memory of the phone are to be used for a purchase, which is petrol in this example. The money to be used in this example is 30 USD. The user may enter the sum 30 USD by using a keyboard 104 of the phone 100. The entered sum is shown on a display 106 of the phone.

As in FIG. 1A, where the stored money was 100 USD, the stored funds may not be exceeded. If the user would try to use 120 USD, an error message would be given and the purchase would be denied.

Upon preliminarily accepting the amount of 30 USD for the purchase, the mobile phone 100 forms a second optically readable code CODE#2 112. CODE#2 can be considered as a new code or a code modified from CODE#1. In addition to the information on the purchase sum, the transaction code CODE#2 also contains information on one or more further identifiers, which may relate to one or more of the following: the mobile phone 100, the information stored on the mobile phone, the user of the mobile phone, the time of the transaction, and the place of the transaction, for instance.

FIG. 1C shows a situation where the mobile phone 100 displays CODE#2 on its display and the user of the mobile phone is prepared to use the defined sum of 30 USD for a purchase. A device 120 is another apparatus which takes part in the purchase event. In this embodiment, when the user is about to refill his car at a petrol station, the device 120 may be a reading device operatively coupled to a petrol pump. The device 120 includes a scanning device, such as a camera, for scanning the machine readable code CODE#2 from the display of the mobile phone.

The code thus contains information on the purchase sum of 30 USD, and also on one or more identifiers for securing the transaction. To secure the transaction, a sufficiently great number of identifiers are applied to make the transaction between the two devices 100 and 120 unique.

One way to secure transactions is that all the original codes 110 allocated to mobile stations such as 100 are different. When the codes are different, all further derivations and modifications of the codes become implicitly different, if the same encryption/decryption algorithm is used in modifying the codes.

Even if the original codes 110 allocated to different phones were the same, the purchase codes 122 can be made different by adding one or several transaction-specific identifiers. Possible identifiers are the location of the phone and the time of the transaction.

At first, when reading the code, the device 120 may check general acceptability of the code. This may be carried out by checking whether the code belongs to a predetermined space of codes that may be accepted. That is, even if the device 100 may create a unique purchase/transaction code from the starting information and the transaction-specific information, it is checked that the created code fulfils a predetermined criterion.

Another way to start a transaction between the two devices 100 and 120 is to use a start code. The device 100 may have a start code stored therein, and when the device 120 reads this code, the transaction starts. This way the second device knows that, within a predetermined time limit, a transaction is to be expected from the device that started the transaction. A start code may alternatively be applied so that the second device has a start code stored therein. The first device reads the start code and may use the information therein to create the first transaction code. The start code may also contain information to be used in generating the transaction code and/or the confirmation code, such as an encryption key, for instance.

When carrying out the transaction, the device 120 may extract the time and location information from the transaction code 112 and verify that they are correct before accepting the transaction.

The identifiers are stored in the device 120 and may subsequently be used to verify the transaction. The petrol station 120 may send to the user 100 a receipt documenting the purchase, and may also use the information as verification when requesting a refund of the sold petrol from a financing institution.

In another embodiment, a personal PIN code may be associated with the code. That is, CODE#2 is formed by using the user's PIN-code that makes the code unique.

In another embodiment, the code may contain an order number and/or time of the purchase. These pieces of information may serve as identifiers in situations where the user wishes to make two purchases at the same location for the same sum.

Upon accepting CODE#2, the gas pump 120 allows the user of the phone 100 to refuel his/her car with the indicated 30 USD.

FIG. 1D shows forming of a confirmation code CODE#3 114. The device 120 forms a confirmation code, which serves as a receipt of the purchase. The confirmation code may include a second identifier (ID_{—}2) further identifying the transaction. The information on the purchase sum, the location of the purchase, and an identifier of the device 120 may be applied, for instance.

In an embodiment, use of the rest of the available funds in the mobile phone 100 is dependent on subsequent reading of the confirmation code 114. In this example, the user has used 30 USD for the purchase and thus there are still 70 USD stored in the phone. These 70 USD remain locked until the user of the mobile phone 100 has successfully read/scanned the confirmation code 114 from the display 122 of the device 120. When the mobile phone has successfully read the code CODE#3, the remaining 70 USD will be unlocked and become available for further purchases.

As another example, it may be considered a situation where the payment method is used in the implementation of a city-specific means of payment. That is, the code may be used as means of payment in public places, such as theatres and swimming halls, and can be used as means of payment when paying a parking fee, for instance.

The procedure begins when the user loads a purchase code to his mobile phone. The loading of the code may be possible upon payment of 50 EUR, for instance. In this example, it is assumed that exactly the same code is loaded to all phones.

When carrying out the transaction/purchase, the mobile phone may add or use the IMEI code of the phone or the IMSI code of the SIM card when modifying the original purchase code to a first purchase code when paying an entry ticket (5 EUR) in a swimming hall. The first purchase code may contain information of the first purchase sum or some other identifiers. While the first purchase is being carried out, the money loaded onto the mobile phone is locked. The swimming hall may have a reading device for reading the first purchase code from the mobile phone. This device converts the original first purchase code to a first confirmation code. The mobile phone reads the confirmation code, and unlocks the locked money (the remaining 45 EUR) on the phone.

When the mobile phone user starts to use the remaining 45 EUR on the phone, a second purchase code is created. The second purchase code may be created by using the original purchase code and the information that 5 EUR have been used of the original 50 EUR, and the IMEI number of the phone. Alternatively, the confirmation code from the first purchase may be used as a basis for generating a purchase/transaction code for the second transaction.

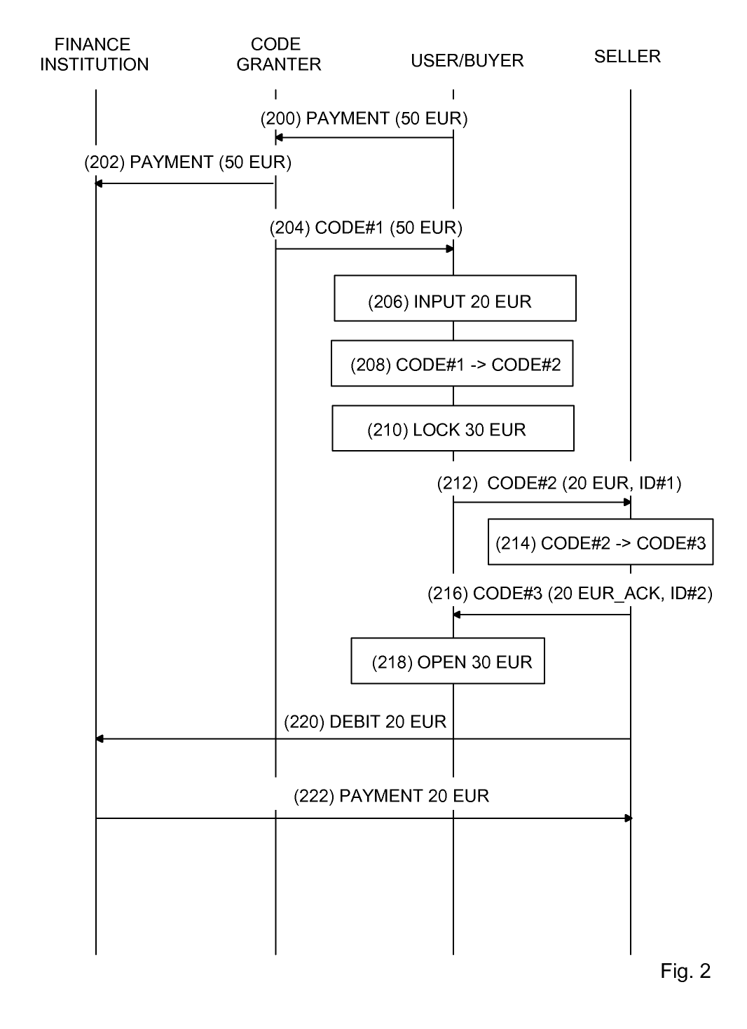

FIG. 2 shows an embodiment of a method. The figure presents four nodes. The node “user/buyer” depicts a combination of a user and his mobile phone, which user is planning to use his mobile phone for paying for goods/services. The node “seller” includes the service provider and his device. The node “code granter” depicts a person and a device that grant a code to the user, and the node “financing institution” is responsible for transfer of money relating to the purchases.

In 200, a person pays 50 EUR to a code granter, which may be a kiosk, for instance. The payment may be carried out by common ways of payment, such as money, credit card and so on. The code granter subsequently transfers in 202 the 50 EUR to a financing institution, such as bank, which is then responsible for crediting the seller for the goods he has sold.

In 204, the paid money, 50 EUR, is loaded to a user device of the person. The money may be loaded in form of an optically readable code or an RF code, for instance. The user device may read the code optically from paper or from a display of the code granter's device, for instance. Alternatively, the code granter's device may send the CODE#1 to the user device in an SMS or an MMS.

In 206, the purchase transaction, where the user buys goods or services from the provider/seller, begins. The user of the user device wishes to use 20 EUR of the available 50 EUR for a purchase. The user then starts in the mobile device an application, which is configured to handle offline payments. The user inputs in 206, by using a keyboard or giving voice instructions to the phone, the amount of 20 EUR to be used for the purchase. The user device then converts the originally stored CODE#1 to another code, CODE#2, which is to be used in the specific purchase event.

After the conversion, the optically readable code contains at least information on the amount of money to be used for the purchase. The code may also contain information on the amount of money that was originally loaded to the phone. Additionally, CODE#2 also contains one or more identifiers for providing a further identifier of the event. Such an identifier may be a phonerelated identifier, such as an IMEI of the user device and/or an IMSI of the subscriber SIM card. As a verifier, the user device may use its location obtained from the GPS (Global Positioning System), for instance. In an embodiment, the date and/or time of the transaction is/are coded into CODE#2.

In an embodiment, CODE#2 is encrypted using an encryption, which can be decrypted by the seller's device.

While the transaction continues, the remaining 30 EUR of the original sum are locked as shown in step 210.

The optically readable code CODE#2 is then transferred to a destination device, that is the device of the seller. The seller's device may read the code optically from the display of the buyer's device by using a mobile phone camera, for instance. If the code is a magnetic code, a device capable of reading a magnetic code is used. If the code is a radio frequency code/tag, an RFID or NFC reading device may be applied.

In 214, the destination device checks the code CODE#2 and forms CODE#3 by forming a completely new code or modifies CODE#2. When forming CODE#3, the seller's device may use one or more identifiers of the seller, that is ID#2. Such an identifier may be an identity of the seller device or the location of the seller device, for instance.

In 216, the buyer's device reads CODE#3 optically from the display of the seller's device. Optical reading in steps 212 and 216 is preferred as it requires no communication in the radio interface. Optical reading between the two devices cannot practically be subjected to fraud.

As in step 208, the code formed in step 214 may be encrypted with an encryption that the buyer's device is able to decrypt.

The purchase procedure between the two devices is only complete when the buyer's device has successfully read the confirmation code CODE#3 and has unlocked the remaining sum of 30 EUR for further purchases.

Subsequently, to complete the monetary transactions, the seller debits the finance institution, which pays the 20 EUR to the seller.

The above procedure provides a safe transaction between two devices. The codes, CODE#2 and CODE#3, are unique to the transaction and are therefore very difficult to misuse. Extra safety is provided by the fact that the reading of the codes is carried out optically between two nearby devices, and thus no-one can practically intervene in the information transfer procedure.

In the above-disclosed embodiments, the two electrical devices may both be aware of and use a common encryption/decryption algorithm for processing the codes/tags that are used in the transaction. Use of a common protocol ensures that the devices are capable of sharing information with each other.

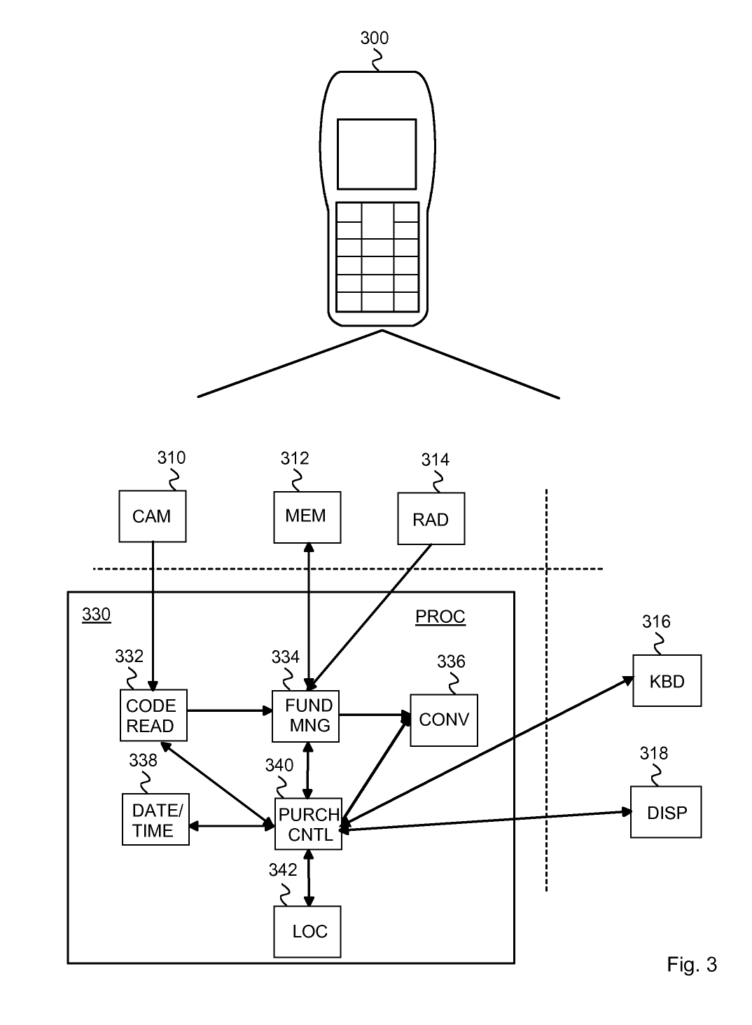

FIG. 3 shows an embodiment of a user apparatus that is a mobile phone 300. The mobile phone comprises a reader device, which is capable of reading codes. In FIG. 3, the reader device is a camera 310 configured to read/scan optically readable codes. The camera may read an optical code, which defines the initial fund reserve that is loaded to the phone. The camera may also read a confirmation code from the display of the device that handles the selling operation. The reader device may alternatively be a device capable of reading radio frequency or magnetic information sources.

The mobile phone also comprises a radio unit 314, which is configured to implement the radio communication of the mobile phone. In an embodiment, an optically readable code defining the initial fund reserve is received as an SMS/MMS message via the radio interface.

The mobile phone 300 also comprises a memory 312 configured to store operating software used by a processor 330 of the mobile phone. The memory may also store optically readable codes, such as the initial fund reserve codes, and received confirmation codes.

The mobile phone 300 also comprises an input device 316. The input device may comprise a keyboard and/or a voice instruction unit. Via the input device, the user of the device may give to the mobile phone an instruction concerning the amount of money to be used for a purchase, for instance.

The processor comprises software functions configured to implement the following functionalities.

A code reader 332 is configured to receive the read code from the camera and extract the digital information contained in the code.

A fund manager unit 334 is configured to manage the funds in the mobile phone. Initially, when the first code is read, the fund manager loads the initial amount of money to the memory of the mobile phone. Thereafter, when a transaction is carried out, the fund manager subtracts the amount of money from the initial fund.

The processor also includes a purchase controller 340, which is responsible for the overall coordination of the purchases. When the user of the mobile phone is starts to carry out a purchase, the user may start a corresponding application by using the keyboard of the phone. When the application is running, the user may first input the amount to be used for the purchase. When the user has input the amount, the purchase controller checks that the amount does not exceed the sum loaded onto the phone. If it does, an error message may be given and the user may be prompted to give an amount which is smaller than the stored money. When a valid sum has been given by the user, the purchase controller triggers a conversion module 336.

The conversion module converts the currently stored optically readable code into a new code, which takes into account the purchase sum and one or more additional identifiers. FIG. 3 shows two software units, which may provide these additional identifiers. A date/time unit is configured to keep track of the current date and time and to provide the date and/or time to the conversion unit 336 when needed. The conversion unit may then code the date and/or time information to the code. Another such unit is a location unit, which may keep track of the location of the mobile phone by using the GPS system, for instance. The location of the phone may be coded into the code when the user device is about to make the purchase.

The conversion unit may also be responsible for encryption/decryption of the codes according to the need. That is, there may be a need to encrypt the purchase code and to decrypt the purchase code.

The mobile phone also comprises a display 318, which is configured to display the optically readable purchase code to be read by another device.

In the previous embodiments, reference has been mainly made to carry out a monetary transaction or payment. However, the transaction may also be a transaction related to some other security document, such as a contract or share, for instance, that is to be transferred between two devices. If we consider that the document is a contract, the following steps may be applied. The originating device adds one or more identifiers to the security document, such that the transaction becomes unique. The receiving device reads the sew curity document and may create a receipt code to be read by the originating device. The receipt code may include one or more identifiers of the destination device. Thus, after the transaction, the document has been transferred and both parties of the transaction have receipts evidencing that a unique transaction has occurred.

The first and/or second electronic device may comprise a processor, which can be a general-purpose processor configured to execute a computer program tangibly recorded on a non-transitory computer-readable recording medium, such as a ROM, hard disk drive, optical memory or flash memory. In this case, the general-purpose processor can be configured to carry out the operative functions described herein by executing the computer program recorded on the non-transitory computer-readable recording medium. In accordance with an exemplary embodiment, the processor can be an application-specific processor that is specifically configured to carry out the operative functions described herein. The non-transitory computer-readable recording medium can be memory-resident and/or communicatively connected to the respective electronic device.

It will be obvious to a person skilled in the art that, as the technology advances, the inventive concept can be implemented in various ways. The invention and its embodiments are not limited to the examples described above but may vary within the scope of the claims.

1-15. (canceled)

16. A method, comprising:
in a funds-storing phase, forming, in a first electronic device, a machine-readable transaction code for identifying an information transaction between the first electronic device and a second electronic device, the transaction code including information on a first security document and on one or more first identifiers for uniquely identifying the transaction; and
in a purchase phase, providing the transaction code at the first electronic device to be receivable by the second electronic device, without using a mobile network.

17. A method according to claim 16, wherein the one or more first identifiers comprise one or more of a location of the first electronic device, a time of the transaction, a device identity of the first electronic device and/or a subscriber identity relating to the first electronic device.

18. The method according to claim 16, comprising:
reading, in the first electronic device, a machine-readable confirmation code from the second electronic device, which confirmation code is formed on the basis of the transaction code and includes one or more second transaction identifiers for identifying the transaction.

19. A method according to claim 16, further comprising:
initiating the transaction by transferring a start code between the first electronic device or in the second electronic device.

20. The method according to claim 16, wherein the method is for electronically transferring money from the first electronic device to the second electronic device, the method comprising:
storing information on total available funds reserve on the first electronic device;
forming, in the first electronic device, the transaction code including information on a purchase price and/or the total available funds reserve in the first electronic device.

21. A method according to claim 20, further comprising:
locking the remaining funds reserve, in which the purchase price has been subtracted from the total funds reserve;
receiving the confirmation code from the second electronic device; and
unlocking the remaining funds reserve when the confirmation code is received in the first device.

22. A method according to claim 20, comprising:
receiving, in the first device, a funds reserve code providing information on the total available funds reserve, which funds reserve code is received by reading the reserve code wirelessly from another device or by receiving the reserve code as part of a radio message.

23. A method according to claim 16, wherein the security document comprises one or more of money, a contract, a share.

24. An electronic device, comprising:
a code creator configured to create, in a funds-storing phase, a machine-readable transaction code for identifying an information transaction between the electronic device and a second electronic device, the transaction code including information on a first security document and on one or more first identifiers for uniquely identifying the transaction; and
a communication unit, configured to provide, in a purchase phase, the transaction code to be receivable by the second electronic device, without using a mobile network.

25. An electronic device according to claim 24, wherein the one or more first identifiers comprise one or more of a location of the first electronic device, a time of the transaction, a device identity of the first electronic device, a subscriber identity relating to the first electronic device.

26. An electronic device according to claim 24, wherein the communication unit is configured to receive a machine-readable confirmation code from the electronic second device, which confirmation code is formed on the basis of the transaction code and one or more second transaction identifiers for identifying the transaction.

27. An electronic device according to claim 24, comprising:
a storing unit configured to store information on a total available funds reserve; and
the code creator is configured to create the machine-readable transaction code including information on a purchase price and/or the total available funds reserve in the first electronic device.

28. An electronic device according to claim 27, further comprising:
a locking unit configured to lock the remaining funds reserve, in which the purchase price has been subtracted from the funds reserve;
the communication unit is configured to receive the confirmation code from the second electronic device; and
an unlocking unit configured to unlock the remaining funds reserve when the confirmation code is received in the first electronic device.

29. An electronic device according to claim 24, wherein the communication unit is configured to receive a funds reserve code providing information on the total available funds reserve, which communication unit is configured to receive the funds reserve code by reading the funds reserve code wirelessly from another device or by receiving the reserve code as part of a radio message.

30. A tangible program carrier comprising program code instructions, wherein execution of the program code instructions on a data processing system causes the data processing system to execute all acts defined in claim 16.
